(19) United States
(12) Patent Application Publication
(10) Pub. No.: US 2009/0046636 A1
(43) Pub. Date: Feb. 19, 2009

(54) ROUTING APPRATUS AND SESSION CONTROL METHOD IN WIRELESS COMMUNICATION SYSTEM

(75) Inventor: Min Kon Kwak, Seoul (KR)

Correspondence Address: BLANK ROME LLP, 600 NEW HAMPSHIRE AVENUE, N.W., WASHINGTON, DC, 20037, US

(73) Assignee: POSDATAQ CO., LTD.

(21) Appl. No.: 12/281,904

(22) PCT Filed: Mar. 30, 2007
(86) PCT No.: PCT/KR2007/001559

§ 371 Date: Sep. 5, 2008

(30) Foreign Application Priority Data
Mar. 31, 2006 (KR) 10-2006-0029446

(51) Int. Cl. H04W 40/02

(52) U.S. Cl. 370/328

(57) ABSTRACT

Provided are a routing apparatus and session control method. The routing apparatus includes: a first processor for performing session control of portable subscriber stations (PSSs); and a second processor for independently performing at least one additional function separated from session control.

### TECHNICAL FIELD

The present invention relates to a wireless communication system, and more particularly, to a routing apparatus and a session control method which take into consideration data loss, delay, and stable reliability, in order to be appropriate for an evolved structure capable of providing high mobility in a wireless portable Internet system conforming to the Institute of Electrical and Electronics Engineers (IEEE)802.16d/e standard, Wireless Broadband (WiBro) standard, Worldwide Interoperability for Microwave Access (WiMAX) standard, and so on.

### BACKGROUND ART

Various in-depth studies aimed at implementing fourth generation mobile communication are currently underway. In fourth generation mobile communication conforming to the Institute of Electrical and Electronics Engineers (IEEE) 802.16d/e standard, Wireless Broadband (WiBro) standard, Worldwide Interoperability for Microwave Access (WiMAX) standard, etc., a wireless local area network (LAN), digital audio broadcasting and video broadcasting networks, etc., as well as a satellite network, are systematically linked and combined into one single network. Thus, users can smoothly receive service, such as portable Internet service, etc., in any network in an optimal state.

FIG. 1 illustrates the environment of a general portable Internet communication system 100. Referring to FIG. 1, communication service, such as telephone service, digital broadcasting, digital media downloading and uploading, etc., can be provided to portable subscriber stations (PSSs) via radio access stations (RASs). The RAS is connected with access control router (ACRs) on the basis of the Ethernet. An Internet protocol (IP) packet routed by control of an ACR is transmitted to and received by a target PSS or server through the corresponding RAS.

In FIG. 1, each RAS perform a bridging function for rapid connection with a PSS, scheduling of wireless resources, and a radio frequency (RF) control function. each ACR that are in charge of the layer 3 (L3) function as IP terminating points route IP packets to enable the PSSs and the RASs to appropriately transmit and receive them. The ACR may link with an authentication/authorization/accounting (AAA) server to perform authentication and accounting functions.

However, since cell coverage of a portable Internet network, such as a general WiBro network, is considerably smaller than that of a Code Division Multiple Access (CDMA) system, signaling traffic for re-authentication and for accounting-processing handoff accompanied with handoff during high-speed movement relatively increases. In addition, the traffic load on an ACR may be increased by the increase of PSSs or service use. Therefore, the capacity or performance of an entire access network deteriorates and cause data loss or delay. Consequently, it may be difficult to provide users with stable and reliable service.

Thus, rather than simply increasing the processing capacity of an ACR, there is a demand for an ACR that facilitates an easy call connection setup and reduces traffic load caused by handoff, in preparation for PSS mobility, and considers the stability and implementation cost of a system, for the sake of operating an access network.

### DISCLOSURE OF INVENTION

### Technical Problem

The present invention is directed to a routing apparatus and session control method in a portable Internet system.

The present invention is also directed to a routing apparatus and session control method which facilitate call connection setup and reduce traffic load caused by handoff in preparation for portable subscriber station (PSS) mobility.

The present invention is also directed to a routing apparatus and session control method which improves the system stability for the sake of operating of an access network and is advantageous for system implementation.

The present invention is also directed to a routing apparatus and session control method which enable a basic function to be effectively added to a data plane.

### Technical Solution

One aspect of the present invention provides a routing apparatus in a wireless communication system, the routing apparatus comprising: a first processor for performing a session control function for portable subscriber stations (PSSs); and a second processor for independently performing at least one of additional functions separated from the session control function.

Another aspect of the present invention provides a session control method in a wireless communication system, comprising the steps of: performing, at a first processor, a session control function for PSSs; and independently performing, at a second processor, at least one of additional functions separated from the session control function while the session control function is performed.

Still another aspect of the present invention provides a routing apparatus in a wireless communication system, the routing apparatus comprising: a data plane for supporting data management and routing functions for an Internet protocol (IP) packet; and a control plane for performing session control of a PSS and independently performing at least one additional function while performing session control.

Yet another aspect of the present invention provides a routing apparatus in a wireless communication system, the routing apparatus comprising: a routing and management processor for supporting data management and routing functions for an IP data packet; a first processor for controlling an IP session for transport of the IP data packet in a control plane; and a second processor for performing at least one of accounting and authentication functions for controlling the IP session.

Yet another aspect of the present invention provides a wireless communication system comprising a router for managing routing of an IP packet by performing IP session control function for PSSs accessing through an RAS and at least one of authentication and accounting in communication with an AAA server, the router separately performing the session control function and at least one of the authentication and accounting functions with at least two independent processors.

### ADVANTAGEOUS EFFECTS

According to the routing apparatus and session control method of the present invention, since a session control function and additional functions, such as authentication, accounting, etc., are distributed to and processed by separate processors, a processor controlling basic call connection setup for Internet protocol (IP) packet transport can be relieved of the burden of processing a large volume of traffic caused by handoff, thus increasing subscriber processing capacity.

In addition, when a large volume of traffic is processed for handoff, independent processors each perform their corresponding function only. Therefore, overall core network control performance improves, so that stable and reliable service can be provided to customers without data loss or delay.

In addition, if an additional basic function, such as paging in an idle mode, etc., is demanded, it can be added to the data plane of an ACR system without changing an overall platform structure.

In addition, system capacity can be expanded by selectively increasing the capacity of an independent session control function processor or additional function processor without requiring to design and add a new ACR processor and there are advantages to reducing maintenance cost and to main system maintenance.

### BRIEF DESCRIPTION OF THE DRAWINGS

FIG. 1 illustrates a general wireless communication system;

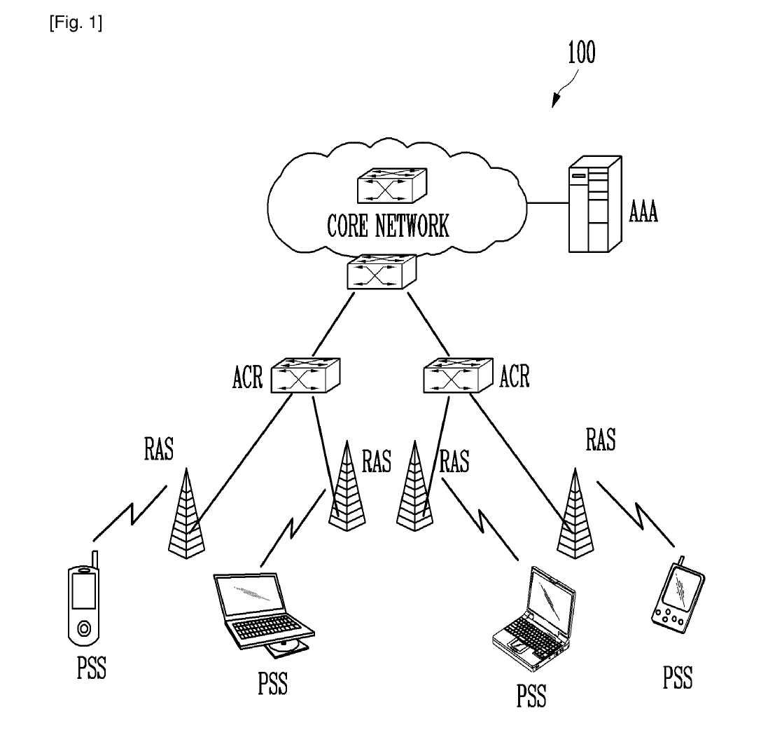

FIG. 2 is a block diagram illustrating a wireless communication system according to an exemplary embodiment of the present invention;

FIG. 3 is a block diagram of an access control router (ACR) according to an exemplary embodiment of the present invention;

FIG. 4 is a flowchart illustrating operations of a session control processor and an additional function processor of an ACR according to an exemplary embodiment of the present invention;

FIG. 5 is a block diagram of a control plane of an ACR according to an exemplary embodiment of the present invention;

FIG. 6 is a block diagram of a data plane of an ACR according to an exemplary embodiment of the present invention;

FIG. 7 is a flowchart of call processing according to an exemplary embodiment of the present invention; and

FIG. 8 is a flowchart of accounting processing according to an exemplary embodiment of the present invention.

Description of Major Elements Appearing in the Above Figures
210: PSS (Portable Subscriber Station)
220: RAS(Radio Access Station)
230: ACR (Access Control Router)
240: Core network
250: AAA (Authentication/Authority/Accounting) server

### MODE FOR THE INVENTION

Hereinafter, exemplary embodiments of the present invention will be described in detail. However, the present invention is not limited to the exemplary embodiments disclosed below, but can be implemented in various forms. The exemplary embodiments are described to enable those of ordinary skill in the art to embody and practice the invention. Like numbers refer to like elements throughout the specification and drawings.

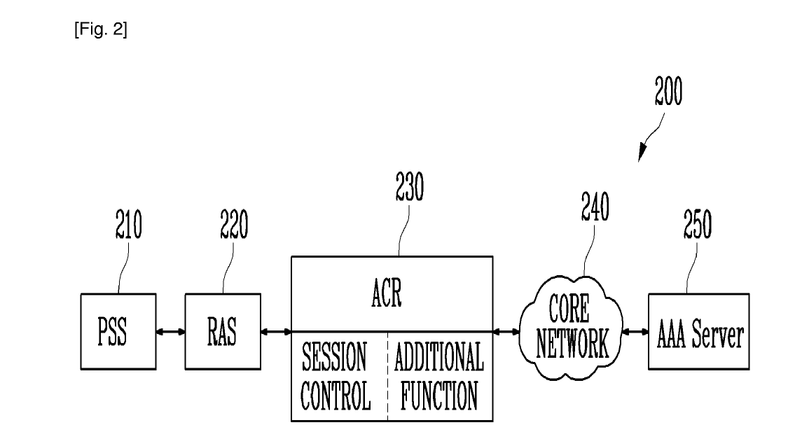

FIG. 2 is a block diagram illustrating a wireless communication system 200 according to an exemplary embodiment of the present invention. Referring to FIG. 2, the wireless communication system 200 comprises portable subscriber stations (PSSs) 210, radio access stations (RASs) 220, access control routers (ACR) 230, a core network 240, and an authentication/authorization/accounting (AAA) server 250. The wireless communication system 200 may further comprise other servers, such as: a home agent (HA) connected with the core network 240 and performing mobile Internet protocol (IP) address registration and allocation, data encapsulation, etc.; a quality manager controlling the quality of a call session; a location register managing the location and status of a PSS; an application server providing a multimedia service, and so on. The wireless communication system 200 may be applied to a fourth generation portable Internet system conforming to the Institute of Electrical and Electronics Engineers (IEEE) 802.16d/e standard, Wireless Broadband (WiBro) standard, Worldwide Interoperability for Microwave Access (WiMAX) standard, and so on.

When the PSS 210 accesses the core network 240, the RAS 220 performs a radio resource control (RRC) function which depends on scheduling of wireless resources, a handoff function supporting mobility between cells, etc., thereby relaying communication between PSSs.

When the PSS 210 accesses the core network 240 through the RAS 220, the ACR 230 manages routing so that an IP packet can be appropriately transmitted and received between the PSS 210 and the RAS 220 while controlling session connection setup for an incoming call and performing AAA processing. The AAA server 250 is connected with the ACR 230 through the core network 240. The ACR 230 generates a message related to AAA processing, transfers the message to the AAA server 250, and processes a response message received from the AAA server 250, thereby managing authentication, accounting, etc. Such an RAS 220 may be combined with the ACR 230 and operate as one system, but it is assumed that the ACR 230 is separated from the RAS 220 and independently operated for the sake of mobility routing in a fourth generation mobile communication network in which a public IP network and a core network are combined. The ACRs 230 may be respectively connected with the RASs 2 20 and managed, or may exist as an independent network element in the core network 240 and perform the above-described functions.

In the present invention, a session control function, which controls basic call connection setup for transport of an IP packet, is separated from additional functions, such as authentication of a subscriber or the PSS 210, accounting, etc., to enable the ACR 230 to efficiently route an IP packet received from the PSS 210 accessing through the RAS 220. In other words, the session control function and the additional functions are distributed to and performed by two independent processors of a control plane in the ACR 230. Therefore, the additional functions and the session control function are not performed by one processor according to this invention. Thus, excessive signaling traffic caused by handoff in a portable Internet network, such as a WiBro network, etc., is efficiently processed, so that subscriber processing capacity can be increased and an economical and convenient communication system can be constructed.

More specifically, network ranging, authentication, service flow control, accounting processing, etc., are necessarily required for the PSS 210 to access the core network 240. In addition, during a session control process, an handoff processing necessarily involves re-authentication, processing accounting information, transporting the process result, etc., and also requires a predetermined buffering device preventing data traffic loss for a seamless session. In such a mobile IP environment, traffic is increased by the increase of subscribers and service use. Therefore, the ACR 230 system load due to session establishment, handoff processing, etc., becomes excessive and This results in deterioration of the entire system performance and reduction of subscriber capacity, which may severely reduce the efficiency of portable Internet businesses such as WiBro, etc.

In network accessing or handoff processing, the additional functions, such as authentication, accounting, etc., of the ACR 230 are secondary functions for subscriber protection and authority, rather than essential functions for session connection setup itself. Thus, the present invention separates such secondary functions from the essential functions such as session control function and distributes the load of session connection setup, thereby the ACR 230 can stably perform routing without traffic delay or loss.

In addition, in the present invention, the control plane of the ACR 230 is implemented by two independent processors. Therefore, the capacity of the system can be increased by selectively increasing the capacity of a session control processor and an additional function processor without remanufacturing the processor of the ACR 230, thus the operating cost is reduced and the maintenance become more easily.

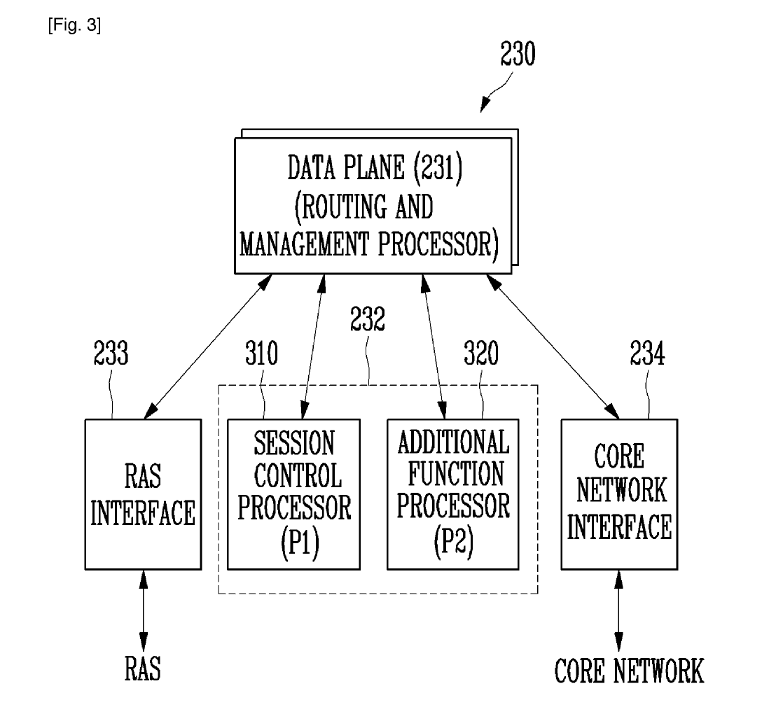

The constitution of the ACR 230 according to an exemplary embodiment of the present invention is illustrated in FIG. 3. Referring to FIG. 3, the ACR 230 comprises a data plane 231, a control plane 232, an RAS interface 233, and a core network interface 234. The control plane 232 is divided into and operates as a session control processor 310 and an additional function processor 320.

The data plane 231 is connected with the RAS 220 through the RAS interface 233 and with the core network 240 through the core network interface 234, and processes data messages exchanged between the RAS 220 and the core network 240 according to predetermined routing protocol. And, when paging occurs in an idle mode, the data plane 231 pages the corresponding PSS 210 according to a paging strategy through the RAS interface 233, establishes a session connection, and then temporarily stores a data message received from the core network interface 234 to transmit data traffic to the corresponding RAS 220 without data loss. In addition, the data plane 231 supports a foreign agent (FA) function depending on whether or not Internet protocol version 4 (IPv4) is supported.

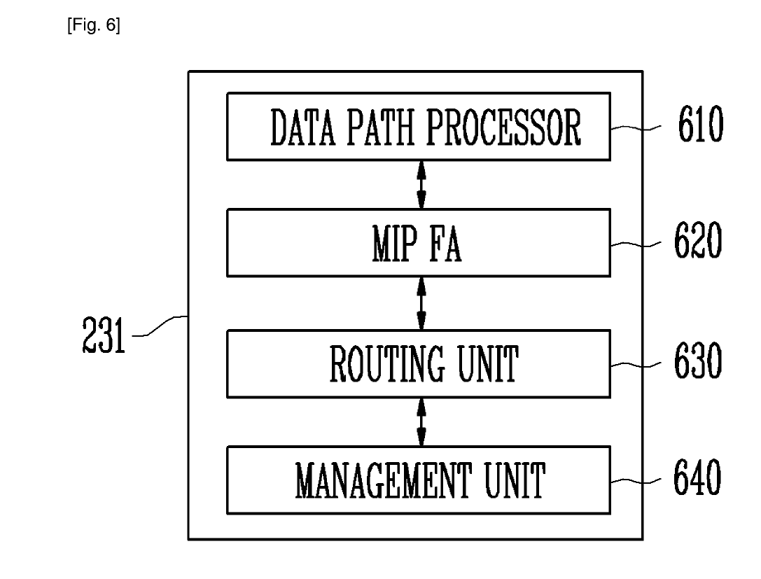

Furthermore, the data plane 231 also controls and manages the session control processor 310 and the additional function processor 320, and also supports management of the ACR 230 for routing an IP packet to or from the PSS 210. The data plane 231 independently controls the session control processor 310 and the additional function processor 320, and also transmits messages between them. The data plane 231 will be described in further detail with reference to FIG. 6.

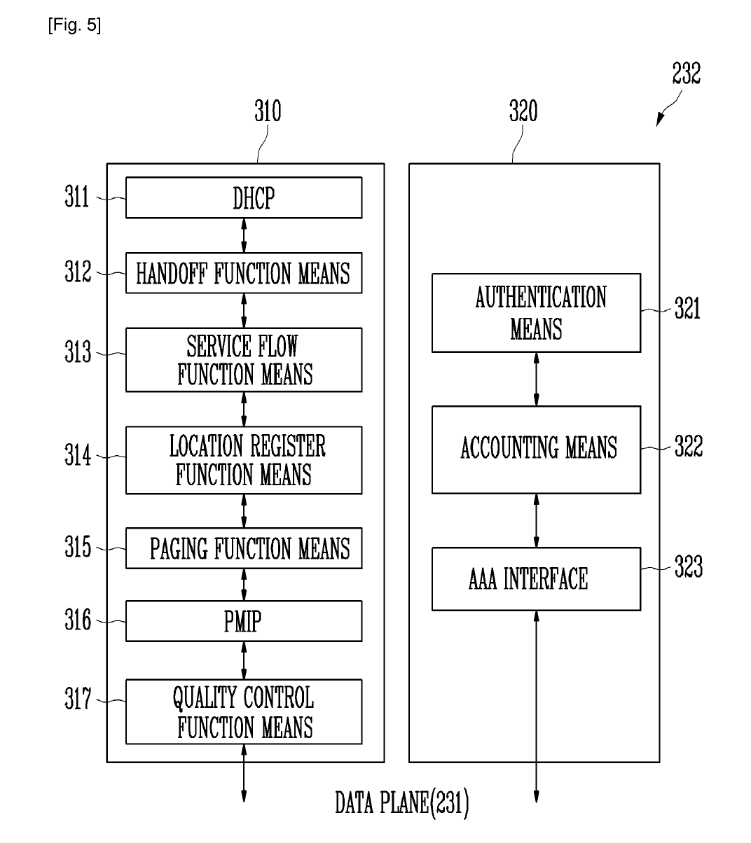

The session control processor 310 controls session establishment so that the PSS 210 can access through the RAS interface 233. In other words, the session control processor 310 controls basic session setup for transport of IP packets. For example, for the sake of session control, the session control processor 310 supports a function of allocating an IP address according to dynamic host configuration protocol (DHCP), a function of processing handoff according to movement of the PSS 210 between cells and the ACRs 230, a service flow function of supporting a scheduling service according to traffic type, a function of registering the current location of a PSS, a paging function of searching the location of the corresponding RAS and paging the RAS when an incoming call is generated, a proxy mobile IP (MIP) function of supporting IP mobility of a PSS, a quality control function of controlling the quality of a current communication service, and so on. The session control processor 310 will be described in detail with reference to FIG. 5.

On the other hand, the additional function processor 320 independently performs additional functions, such as authentication, accounting, etc., during session control processing. For example, the additional function processor 320 authenticates the PSS 210 or a subscriber accessing the core network 240 by communicating with the AAA server 250 via the core network interface 234, reports the authentication result to the session control processor 310, and only when the authentication result is successful, the session control processor 310 controls a session to be established according to the corresponding authority. In addition, when the PSS 210 is allocated an IP address and accesses the core network 240 according to the session established by the session control processor 310, the additional function processor 320 performs accounting for use in communication with the AAA server 250.

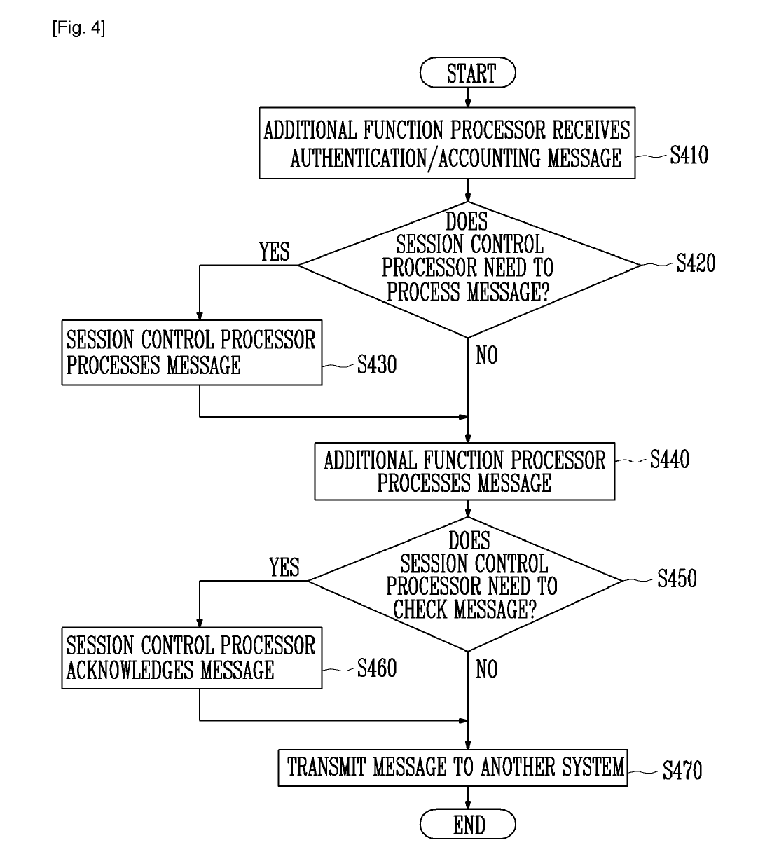

FIG. 4 is a flowchart illustrating operations of the session control processor 310 and the additional function processor 320 of the ACR 230 according to an exemplary embodiment of the present invention. First, when the additional function processor 320 receives a predetermined message, e.g., an authentication/accounting message, associated with an additional function (step 410), it may determine whether there is a message to be processed by the session control processor 310 in relation to the pre-determined message (step 420). For example, the additional function processor 320 may request the session control processor 310 for predetermined session management information, and the session control processor 310 may transfer the information to the additional function processor 320 in response to the request (step 430). When the information is received from the session control processor 310, the additional function processor 320 processes the authentication/accounting message with reference to the received information (step 440). When it is determined in step 420 that there is no message to be processed by the session control processor 310, the additional function processor 320 processes the authentication/accounting message without reference to information received from the session control processor 310 (step 440).

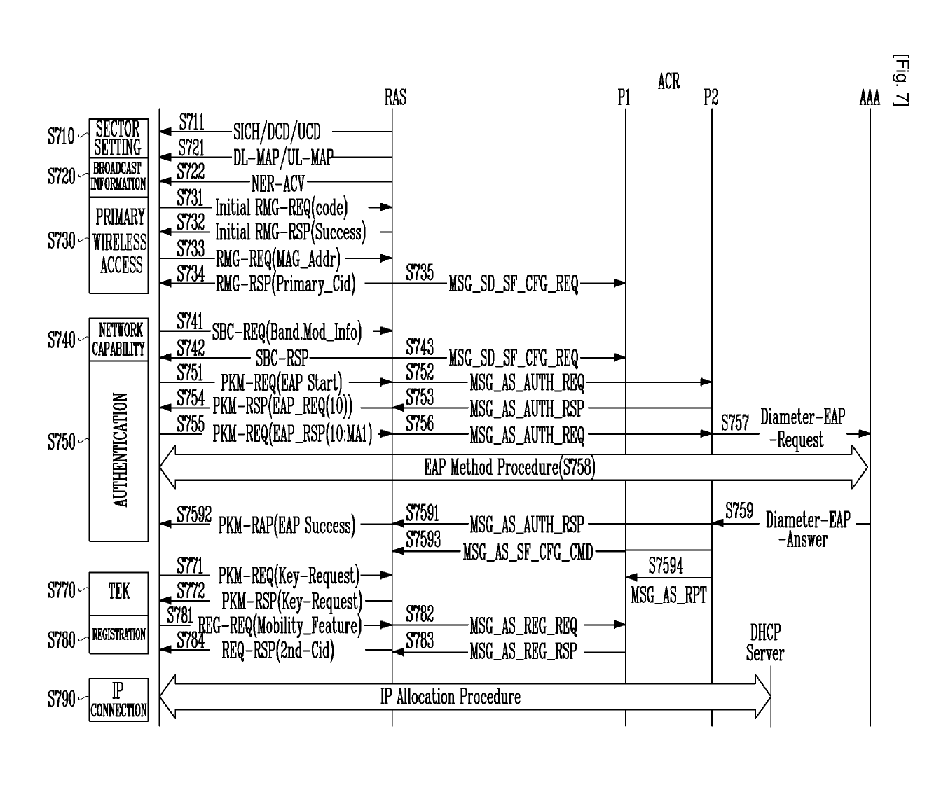

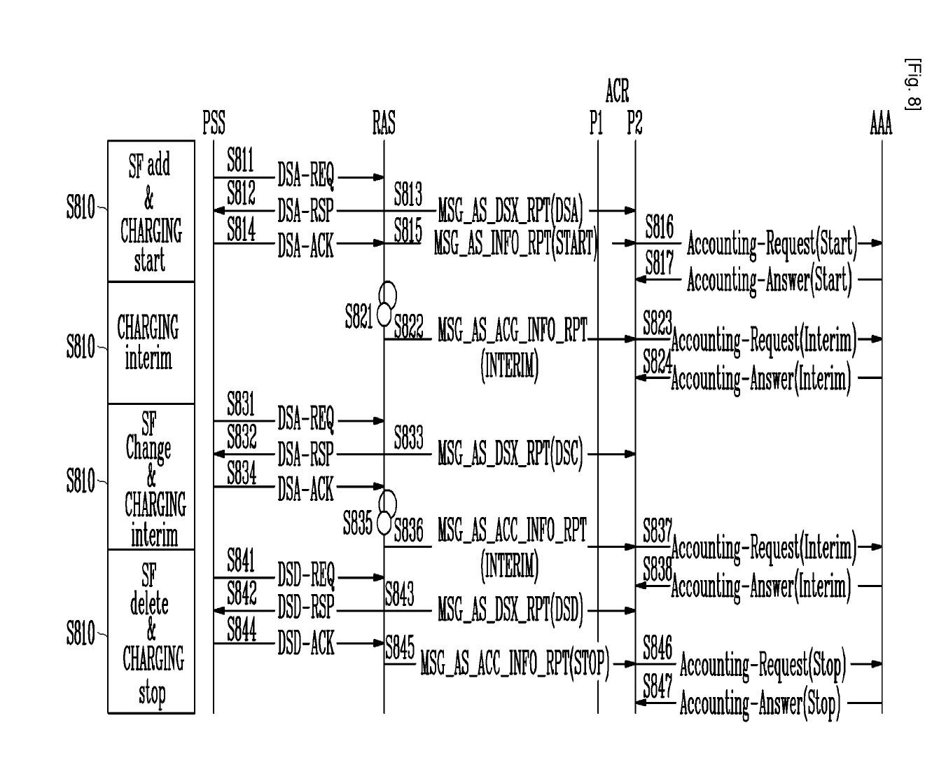

After the additional function processor 320 processes the authentication/accounting message, it may determine whether it is needed to report the process result to the session control processor 310 and receive acknowledgment of the report from the same (step 450). Here, the additional function processor 320 may transfer a predetermined message according to the process result to the session control processor 310, and the session control processor 310 may transfer acknowledgment information indicating that the result was normally reported to the additional function processor 320 in response to the predetermined message (step 460). When the acknowledgment information is received from the session control processor 310, the additional function processor 320 may transfer a predetermined message according to the processor result to another system, e.g., the RAS 220, the AAA server 250, etc. (step 470). When it is determined in step 450 that it is not needed to report the process result to the session control processor 310, the additional function processor 320 may not wait for a response from the session control processor 310 but transmit a predetermined message according to the process result to the RAS 220, the AAA server 250, etc. (step 470). Operations of the session control processor 310 and the additional function processor 320 are described in brief here but will be described in further detail later with reference to FIGS. 7 and 8.

FIG. 5 is a block diagram of the control plane 232 of the ACR 230 according to an exemplary embodiment of the present invention. Referring to FIG. 5, the session control processor 310 of the control plane 232 comprises a DHCP function means 311, a handoff function means 312, a service flow function means 313, a location register function means 314, a paging function means 315, a proxy MIP means 316, and a quality control function means 317. In FIG. 5, the additional function processor 320 of the control plane 232 includes an authentication means 321, an accounting means 322, and an AAA interface 323.

The DHCP 311 performs supporting an IP address allocation function according to the DHCP. The DHCP is a protocol managing an IP address and configuration information for the IP address and dynamically allocating an IP address to a client, i.e., the PSS 210, in a network. For a predetermined lease time, e.g., several tens of minutes, the PSS 210 uses the allocated IP address and may request the DHCP 311 to extend the lease in order to continue using the IP address after expiration of the lease.

When handoff occurs due to movement of the PSS 210 between cells or the ACRs 230, the handoff processor 312 manages session management information and routing information to seamlessly maintain an established session in response to a handoff request.

According to the type of traffic originating from the PSS 210, the service flow function means 313 supports a scheduling service, such as an unsolicited grant service (UGS), a real time polling service (Rt-PS), an extended real time polling service (Ert-PS), a non-real time polling service (Nrt-PS), a best effort service (BES), and so on. For example, the UGS is a service for real time voice traffic, such as voice over IP (VoIP), and the Rt-PS is a service for variable-length real time video traffic, such as video on demand (VoD) for video phones. The Ert-PS extending its bandwidth due to competitive requests of PSSs is a service for real time video traffic. The Nrt-PS is a service for variable-length non-real time traffic according to a protocol requiring a high bandwidth, such as a file transfer protocol (FTP), and the BES is a service for providing general traffic, such as e-mail, with a best effort scheduling service.

The location register function 314 registers the location of the currently accessing PSS 210. For example, when the PSS 210 enters the service area of the specific RAS 220, the location registering function 314 temporarily stores and manages subscriber information, such as location information of the PSS 210, a subscriber's number, the PSS's number, a routing number, and so on.

When an incoming call is generated from the currently accessing PSS 210, the paging function means 315 searches the location of the corresponding RAS 220. Upon generation of the incoming call, the paging function means 315 may generate and transmit a paging signal to all the RASs 220 in its service area.

The proxy MIP means 316 supports IP mobility of the PSS 210. An MIP guarantees PSS mobility and simultaneously enables use of the Internet without change in IP address, regardless of geographical location, even when the PSS 210 moves to another subnet. The proxy MIP means 316 performs such a function to support IP mobility of the moving PSS 210.

The quality control function means 317 controls the quality of a current communication service. For example, a call completion rate, a processor fault, a main device fault, service stability, service satisfaction, etc., are statistically analyzed, and communication quality is controlled to maintain the best service appropriate for the traffic of a game service, a VoIP service, a VoD service, email, a measured rate system, and so on.

By performing the above-described functions, the session control processor 310 controls session establishment with the accessing PSS 210. And, the additional function processor 320 performs additional functions, such as authentication/accounting, etc., separated from the session establishment control function of the session control processor 310 and distributed thereto.

In FIG. 5, when a predetermined authentication request message is received from the RAS 220, the authentication means 321 of the additional function processor 320 requests the AAA server 250 connected with the core network 240 for authentication according to a predetermined authentication algorithm, e.g., an extensible authentication protocol (EAP) method. After the AAA server 250 completes authentication, the authentication means 321 transmits the corresponding authentication response message according to a response received from the AAA server 250. The AAA server 250 requests the PSS 210 for predetermined authentication information according to a diameter protocol, analyzes the information, and thereby can perform authentication. The data messages used when the authentication means 321 communicates with the AAA server 250 are converted by the AAA interface 323 to conform to the corresponding transmission and reception protocol. The authentication means 321 of the additional function processor 320 will be described in further detail with reference to FIG. 7.

When a predetermined accounting processing message is received from the RAS 220, the accounting means 322 of the additional function processor 320 requests the AAA server 250 connected with the core network 240 to charge for the corresponding service. Then, the accounting means 322 receives a response from the AAA server 250 and manages accounting processing. Before a session established for the PSS 210 is terminated, the accounting means 322 may receive accounting information from the RAS 220 at predetermined interims and request the AAA server 250 for accounting. In addition, when the currently connected PSS 210 changes a service, the accounting means 322 may receive service change information from the RAS 220 and manage accounting processing. Here, when a new service conforms to a different accounting policy than the previous service, the accounting means 322 may request the AAA server 250 for accounting according to the changed service. Data of messages used when the accounting means 322 communicates with the AAA server 250 are converted by the AAA interface 323 to conform to the corresponding transmission and reception protocol. The accounting means 322 of the additional function processor 320 will be described in further detail with reference to FIG. 8.

FIG. 6 is a detailed block diagram of the data plane 231 of the ACR 230. Referring to FIG. 6, a routing and management processor of the data plane 231 comprises a data path means 610, an MIP FA 620, a routing means 630, and a management means 640.

The data path means 610 stores and manages a data message transmitted and received between the PSS 210 and the core network 240 so that the messages can be accurately transmitted to its destination without data loss. The HA transmits a data message to the MIP FA 620 through tunneling technique.

The MIP FA 620 transmits the data message to the HA by de-tunneling technique and transmits an associated data message to a registered PSS. The routing means 630 performs a routing function according to a routing protocol so that a data message received by the ACR 230 can be transmitted to its destination. The management means 640 performs configuration, initialization, status management, and statistic functions for operation of the ACR 230.

FIG. 7 is a flowchart of call processing according to an exemplary embodiment of the present invention. Referring to FIG. 7, the session establishment control and authentication processing control process of the ACR 230 for call connection of the PSS 210 comprises a sector setting process (step 710), a broadcast information broadcasting process (step 720), an initial wireless access process (step 730), a network capability negotiation process (step 740), an authentication process (step 750), a traffic encryption process (step 770), a registration process (step 780), and an IP allocation process (step 790).

First, in the sector setting process (step 710), the RAS 220 transmits a MAC (medium access control layer) message, such as a system information channel (SICH), downlink channel descriptor (DCD), uplink channel descriptor (UCD), etc., to the PSS 210 (step 711). Such MAC messages may include system information indicating the characteristics of the physical layer, RAS connection information, power control information, and so on.

In addition, in the broadcast information broadcasting process (step 720), the RAS 220 transmits DL_MAP and UL_MAP messages, which are MAC management messages, to the PSS 210 (step 721). Here, a MAC protocol (MAP) message, which broadcasts the result of dynamically allocating resources to each subscriber of the PSS 210, may include band allocation information, data frame constitution information, and so on. Subsequently, the RAS 220 transmits a neighbor advertise (NBR_ADV) message to the PSS 210, thereby broadcasting its neighborhood information, i.e., update information required for routing (step 722).

In the initial wireless access process (step 730), in order to access the ACR 230 through the RAS 220, the PSS 210 first transmits an initial ranging request message (Initial RNG_REQ) including a predetermined code to request information for initial timing synchronization (step 731). In response to the request, the RAS 220 inserts pre-determined information for success of initial ranging into an initial ranging response message (Initial RNG_RSP) and transmits it to the PSS 210 (step 732). When initial synchronization, such as timing adjustment, power control, frequency error control, etc., is thus achieved in the PSS 210, the PSS 210 transmits a ranging request message (RNG_REQ) including a MAC address to the RAS 220 in order to actually access the ACR 230 through the RAS 220 (step 733). In response to this, the RAS 220 transmits a ranging response message (RNG_RSP) including a primary connection identification (ID) to the PSS 210 (step 734). Here, the RAS 220 transmits a message (MSG_AS_SF_CFG_REQ) to request configuration of a service flow to the session control processor 310 of the ACR 230 (step 735). By the initial wireless access process (step 730), the PSS 210 completes to synchronize with the RAS 220 using the primary connection ID, and the session control processor 310 prepares for scheduling for an appropriate service flow of the corresponding traffic, to perform session establishment control.

Subsequently, in the network capability negotiation process (step 740), the PSS 210 transmits an SBC_REQ message including bandwidth and modulation information, etc., to the RAS 220 for a subscriber station s basic capability negotiation (step 741). In response to this, the RAS 220 transmits an SBC_RSP message to the PSS 210 (step 742) and an authentication policy report message (MSG_AS_AUTH_POLICY_RPT) to the session control processor 310 in preparation for authentication (step 743).

Subsequently, in the authentication process (step 750), the PSS 210 transmits a privacy key management request message (PKM_REQ) to the RAS 220 in order to begin authentication according to the EAP method, etc. (step 751). In response to this, the RAS 220 transmits a predetermined authentication request message (MSG_AS_AUTH_REQ) to the additional function processor 320 of the ACR 230 (step 752). Hereupon, the additional function process 320 transmits a predetermined authentication response message (MSG_AS_AUTH_RSP) to the RAS 220 (step 753), and the RAS 220 transmits a message to request an ID for authentication (PKM_RSP) to the PSS 210 (step 754). Here, the PSS 210 transmits a privacy key management request message (PKM_REQ) including an ID, such as a network access ID (NAI), to the RAS 220 (step 755). Hereupon, the RAS 220 transmits a message (MSG_AS_AUTH_REQ) to request actual authentication to the additional function processor 320 (step 756).

In step 756, in the additional function processor 320, the authentication means 321 transmits a message (Diameter_EAP_REQ) to request authentication according to a predetermined authentication algorithm, e.g., the EAP method, to the AAA server 250 connected with the core network 240 (step 757). Here, the AAA server 250 may request the PSS 210 for predetermined authentication information and analyze it according to the EAP method and the diameter protocol, thereby performing authentication (step 758). Authentication may be performed with reference to verification of rights of the corresponding subscriber. After the AAA server 250 completes authentication, it transmits a predetermined response message (Diameter_EAP_Answer) to the authentication means 321 (step 759). Then, the authentication means 321 transmits an authentication response message (MSG_AS_AUTH_RSP) corresponding to the received message to the RAS 220 (step 7591). Here, the authentication means 321 may transmit, as a response to step 735, a command message (MSG_AS_SF_CFG_CMD) reporting that the service flow is configured to be appropriate for the corresponding traffic to the RAS 220 (step 7593). In addition, the authentication means 321 may transmit a message (MSG_AS_RPT) reporting authentication process result to the session control processor 310 (step 7594).

The RAS 220 transmits a message (PKM_RSP) to report that the authentication according to the EAP method is successful to the PSS 210 (step 7592). Hereupon, the PSS 210 prepares for the traffic encryption process, i.e., step 770.

In the traffic encryption process (step 770), the PSS 210 transmits a message (PKM_REQ) to the RAS 220 requesting it for an encryption key (step 771), and receives a response message (PKM_RSP) from the RAS 220 (step 772), thereby encrypting traffic data. Subsequently, in the registration process (step 780), the PSS 210 and the RAS 220 request the session control processor 310 for location registration using messages (REG_REQ and MSG_AS_REG_REQ) (steps 781 and 782) and receive response messages (MSG_AS_REG_RSP and REG_RSP) (steps 783 and 784), thereby registering the location. Here, the PSS 210 may receive a connection ID from the RAS 220.

Hereupon, the PSS 210 is allocated an IP address from the DHCP 311, so that a call can be connected with a counterpart PSS or, an application server, etc. (step 790).

In this way, after the IP address is allocated to the PSS 210 according to session establishment control of the session control processor 310 and authentication processing of the additional function processor 320, the PSS 210 transmits a message requesting to dynamically add a service to the RAS 220. Then, the PSS 210 can receive the service thorough the connected call, and the accounting means 322 of the additional function processor 320 begins to operate.

As described with reference to FIG. 4, the additional function processor 320 may request the session control processor 310 for the predetermined session management information, and when the information is received from the session control processor 310, process the corresponding authentication message with reference to the received information. In addition, subsequently, when the additional function processor 320 processes the authentication message, it may transmit a predetermined message according to the processing result to another system, e.g., the RAS 220, the AAA server 250, etc., after reporting the processing result to the session control processor 310 and receiving the acknowledgment.

FIG. 8 is a flowchart of accounting processing according to an exemplary embodiment of the present invention. Referring to FIG. 8, the accounting control process of the ACR 230 comprises a process of adding a service flow and starting accounting (step 810), a process of accounting at predetermined interims (step 820), a process of changing a service flow and accounting at predetermined interims (step 830), and a process of deleting a service flow and stopping accounting (step 840). By the additional function processor 320 of the ACR 230, the accounting process is independently performed even during the session control process or authentication process illustrated in FIG. 7.

First, in the process of adding a service flow and starting accounting (step 810), the PSS dynamically transmits a message for adding a service flow (dynamic service addition (DSA)_REQ) to the RAS 220 (step 811). In response to this, the RAS 220 transmits a message (DSA_RSP) to the PSS 210 (step 812) and also a message reporting the addition of a service flow (MSG_AS_DSX_RPT) to the accounting means 322 of the additional function processor 320 (step 813). Hereupon, the accounting means 322 becomes active and begins to manage accounting processing.

The PSS transmits a DSA_ACK message to the RAS 220 in response to the message (step 814). Then, the RAS 220 transmits a message (MSG_AS_ACC_INFO_RPT) reporting accounting information in order to report the start of accounting to the accounting means 322 of the additional function processor 320 (step 815). Here, when the MSG_AS_ACC_INFO_RPT message is received from the RAS 220, the accounting means 322 transmits a message (Accounting_Request) to request accounting according to the corresponding service to the AAA server 250 connected with the core network 240 (step 816). Subsequently, the accounting means 322 receives a response message (Accounting_Answer) informing of the start of accounting from the AAA server 250 and manages accounting processing (step 817).

In the process of accounting at predetermined interims (step 820), the RAS 220, which has transmitted the MSG_AS_ACC_INFO_RPT message to the accounting means 322 in step 815, is in an idle state associated with accounting (step 821). Before a session of the currently connected PSS 210 is terminated in the idle state, the RAS 220 may transmit a message (MSG_AS_ACC_INFO_RPT) reporting accounting information to the accounting means 322 at predetermined interims (step 822). Here, the predetermined interims are several tens of seconds, etc. Hereupon, before the session of the currently connected PSS 210 is terminated, the accounting means 322 may receive the accounting information message (MSG_AS_ACC_INFO_RPT) from the RAS 220 at predetermined interims and request the AAA server 250 for accounting (step 823). Then, the accounting means 322 receives a response message (Accounting_Answer) informing of accounting processing from the AAA server 250 and manages accounting processing (step 824).

In the process of changing a service flow and accounting at predetermined interims (step 830), the connected PSS 210 transmits a message (DSC_REQ) for dynamically changing the service flow to the RAS 220 to change a service (step 831). In response to this, the RAS 220 transmits a message (DSC_RSP) to the PSS 210 (step 832) and also a message (MSG_AS_DSX_RPT) reporting the change of the service flow to the accounting means 322 of the additional function processor 320 (step 833). Hereupon, the accounting means 322 begins to manage change in accounting processing.

The PSS 210 transmits a DSA_ACK message to the RAS 220 in response to the message (step 834). Here, when a new service conforms to a different accounting policy than the previous service, the accounting means 322 may request the AAA server 250 for accounting according to the changed service.

The RAS 220, which has transmitted the MSG_AS_DSX_RPT message to the accounting means 322 in step 833 as described above, is in the idle state associated with accounting (step 835). Before the session of the currently connected PSS 210 is terminated in the idle state, the RAS 220 may transmit the message (MSG_AS_ACC_INFO_RPT) reporting accounting information to the accounting means 322 at predetermined interims (step 836). Hereupon, before the session of the currently connected PSS 210 is terminated, the accounting means 322 may receive the accounting information message (MSG_AS_ACC_INFO_RPT) from the RAS 220 at predetermined interims and request the AAA server 250 for accounting (step 837). Then, the accounting means 322 receives a response message (Accounting_Answer) informing of accounting processing from the AAA server 250 and manages accounting processing (step 838).

In the process of deleting a service flow and stopping accounting (step 840), the currently connected PSS 210 transmits a message (DSD_REQ) for dynamically deleting the service flow to the RAS 220 in order to stop the service (step 841). In response to this, the RAS 220 transmits a message (DSD_RSP) to the PSS 210 (step 842) and also a message (MSG_AS_DSX_RPT) reporting deletion of the service flow to the accounting means 322 of the additional function processor 320 (step 843). Hereupon, the accounting means 322 begins to manage stop of accounting processing.

The PSS 210 having received the DSD_RSP message transmits a DSD_ACK message to the RAS 220 in response to the message (step 844). Then, the RAS 220 transmits a message (MSG_AS_ACC_INFO_RPT) reporting residual accounting information to the accounting means 322 of the additional function processor 320 in order to inform of the stop of accounting (step 845). Here, when the MSG_AS_ACC_INFO_RPT message is received from the RAS 220, the accounting means 322 transmits an Accounting_Request message for processing residual accounting for the service and stopping accounting to the AAA server 250 connected with the core network 240 (step 846). In response to this, the accounting means 322 receives an Accounting_Answer message informing that accounting is stopped from the AAA server 250 and stops accounting processing (step 847). Consequently, the session connection with the PSS 210 is terminated.

As described with reference to FIG. 4, the additional function processor 320 may request the session control processor 310 for the predetermined session management information, and when the information is received from the session control processor 310, process the corresponding accounting message with reference to the received information. In addition, subsequently, when the additional function processor 320 processes the authentication message, it may transmit a predetermined message according to the processing result to another system, e.g., the RAS 220, the AAA server 250, etc., after reporting the processing result to the session control processor 310 and receiving the acknowledgment.

Thus far, it has been described that traffic processing capacity can be increased by independently performing the session control function and additional functions, such as authentication, accounting, etc., with the two processors of the control plane 232 of the ACR 230.

Even after a session for accounting has begun, the operation of the ACR 230 for processing authentication or accounting is performed according to services or due to handoff. For this reason, traffic on a conventional ACR is increased, the ACR experiences an overload, and thus the capacity and performance of the system may suddenly deteriorate. In the present invention, however, two processors of the control plane 232 of the ACR 230 perform distributed processing as described above, so that system performance cannot be deteriorated.

As illustrated in FIGS. 7 and 8, the ACR 230 bears the heavy burden of session control for basic call connection. Thus, in consideration of a handoff, a service flow addition or a service flow addition, the ACR 230 separately operates the session control processor 310 and the additional function processor 320. Thereby, the capacity of the session control processor 310 significantly is increased.

The functions used in the method and apparatus disclosed in this specification can be stored on a computer-readable recording medium in the form of computer code. The computer-readable recording medium may be any recording device storing data that can be read by computer systems. For example, the computer-readable recording medium may be a read-only memory (ROM), a random-access memory (RAM), a compact disk read-only memory (CD-ROM), a magnetic tape, a floppy disk, an optical data storage device, and so on. Also, the recording medium may be carrier waves, e.g., transmission over the Internet. In addition, the computer-readable recording medium may be distributed among computer systems connected via a communication network and stored in the form of a code that can be read and executed by a de-centralized method.

While the invention has been shown and described with reference to m certain exemplary embodiments thereof, it will be understood by those skilled in the art that various changes in form and details may be made therein without departing from the spirit and scope of the invention as defined by the appended claims.

1. A routing apparatus in a wireless communication system, the routing apparatus comprising:
a first processor for performing a session control function for portable subscriber stations (PSSs); and
a second processor for independently performing at least one of additional functions separated from the session control function.

2. The routing apparatus of claim 1, wherein the additional functions are authentication and accounting functions.

3. The routing apparatus of claim 2, wherein when receiving a message associated with the additional functions, the second processor requests session management information to the first processor and processes the message according to the session management information

4. The routing apparatus of claim 3, wherein after processing the message, the second processor transmits the processing result to at least one of the first processor, a radio access station (RAS), and an authentication/authorization/accounting (AAA) server.

5. The routing apparatus of claim 1, wherein the first processor performs the session control function using at least one of an Internet protocol (IP) address allocation function according to dynamic host configuration protocol (DHCP), a handoff function, a service flow function supporting a scheduling service according to traffic type, a function of registering a current location of a PSS, a paging function of searching a location of a corresponding radio access station (RAS) upon an incoming call, a proxy mobile IP (MIP) function supporting IP mobility of a PSS, and a quality control function of controlling quality of a current communication service.

6. A session control method in a wireless communication system, comprising the steps of:
performing, at a first processor, a session control function for PSSs; and independently performing, at a second processor, at least one of additional functions separated from the session control function while the session control function is performed.

7. The session control method of claim 6, wherein the additional functions are authentication and accounting functions.

8. The session control method of claim 7, wherein the step of independently performing at least one of additional functions comprises the steps of:
receiving, at the second processor, a message associated with the additional function;
requesting, at the second processor, session management information to the first processor and
processing, at the second processor, the message according to session management information.

9. The session control method of claim 8, further comprising the step of:
after the second processor processes the message, transmitting, at the second processor, the processing result to at least one of the first processor, a RAS, and an AAA server.

10. The session control method of claim 6, wherein the session control function includes at least one of an IP address allocation function according to DHCP, a handoff function, a service flow function supporting a scheduling service according to traffic type, a function of registering a current location of a PSS, a paging function of searching a location of a corresponding RAS upon an incoming call, a proxy MIP function supporting IP mobility of a PSS, and a quality control function of controlling quality of a current communication service.

11. A routing apparatus comprising:
a data plane for supporting data management and routing functions for a IP packet; and
a control plane for performing session control of a PSS and independently performing at least one additional function while performing session control.

12. The routing apparatus of claim 11, wherein the additional functions are authentication and accounting functions.

13. A routing apparatus comprising:
a routing and management processor for supporting data management and routing functions for a IP data packet;
a first processor for controlling an IP session for transport of the IP data packet in a control plane; and
a second processor for performing at least one of accounting and authentication functions for controlling the IP session.

14. The routing apparatus of claim 13, wherein the second processor processes at least one of messages associated with authentication and accounting in communication with an AAA server connected with a core network.

15. The routing apparatus of claim 13, wherein the first processor controls the IP session using at least one of an IP address allocation function according to DHCP, a handoff function, a service flow function supporting a scheduling service according to traffic type, a function to register a current location of a PSS, a paging function to find out a location of a corresponding RAS and page upon an incoming call, a proxy MIP function supporting IP mobility of a PSS, and a quality control function to control quality of a current communication service.

16. The routing apparatus of claim 13, wherein the second processor comprises:
an authentication means for receiving a predetermined authentication request message from a RAS requesting an AAA server connected with a core network for authentication according to a predetermined authentication algorithm and transmitting a corresponding authentication response message to the RAS according to a response received from the AAA server after the AAA server completes authentication.

17. The routing apparatus of claim 16, wherein the predetermined authentication algorithm is an extensible authentication protocol (EAP) method.

18. The routing apparatus of claim 13, wherein the second processor comprises:
an accounting means for receiving a predetermined accounting processing message from a RAS, requesting an AAA server connected with a core network for accounting according to a corresponding service, receiving a response from the AAA server, and managing accounting processing.

19. The routing apparatus of claim 18, wherein when a service of a PSS is changed, the second processor receives service change information from the RAS and manages accounting processing.

20. A wireless communication system comprising:
a router for managing routing of an IP packet by performing session control function for PSSs accessing through a RAS and at least one of authentication and accounting in communication with an AAA server wherein the router separately performs the session control function and at least one of authentication and accounting functions by at least two independent processors.

21. The wireless communication system of claim 20, wherein the at least two processors comprise:
a first processor performing the session control function and
a second processor independently performing the at least one of the authentication and accounting functions while session control is performed.

22. The wireless communication system of claim 21, wherein the first processor comprises:
a DHCP means for allocating IP addresses to the PSSs according to a pre-determined protocol;
a handoff means for supporting handoff of the PSSs;
a service flow means for providing a predetermined scheduling service according to traffic type served to the PSSs;
a location register means for supporting to register locations of the PSSs;
a paging means for searching a location of a corresponding RAS when an incoming call is generated from the PSSs;
a proxy MIP means for providing IP mobility of the PSSs; and
a quality control means for controlling quality of a communication service currently provided to the PSSs.

23. The wireless communication system of claim 21, wherein the second processor comprises:
an authentication means for, when an authentication request message is received from the RAS, requesting the AAA server connected with the core network for authentication according to a predetermined authentication algorithm and transmitting an authentication response message to the RAS according to an authentication response received from the AAA server; and
a accounting means for accounting receiving a accounting processing message from the RAS, requesting the AAA server for accounting according to a corresponding service, receiving a response from the AAA server, and managing accounting processing.
